(19) United States
(12) Patent Application Publication
(10) Pub. No.: US 2026/0296829 A1
(43) Pub. Date: Oct. 1, 2026

(54) THREAD SPOOL

(71) Applicant: BROTHER KOGYO KABUSHIKI KAISHA, Nagoya (JP)

(72) Inventor: Yuta KAMIHIRA, Yokkaichi (JP)

(73) Assignee: BROTHER KOGYO KABUSHIKI KAISHA, Nagoya (JP)

(21) Appl. No.: 19/629,524

(22) Filed: Mar. 26, 2026

(30) Foreign Application Priority Data
Mar. 27, 2025 (JP) 2025-054279

(51) Int. Cl. B65H 75/18; B65H 75/14; G06K 19/06; G09F 3/00

(52) U.S. Cl. CPC B65H 75/182; B65H 75/148; G06K 19/06037; G09F 3/0297; B65H 2701/31

(57) ABSTRACT

A thread spool includes a cylinder having a hole extending in an axial direction. The cylinder includes an outer circumferential surface and a first surface. A thread is wound around the outer circumferential surface. The first surface is located at one end of the cylinder in the axial direction. A data matrix is disposed on the first surface.

### REFERENCE TO RELATED APPLICATIONS

This application claims priority from Japanese Patent Application No. 2025-054279 filed on Mar 27, 2025. The entire content of the priority application is incorporated herein by reference.

### BACKGROUND ART

A thread spool is used with a sewing machine. A thread is wound around the thread spool.

### SUMMARY

A thread spool has a cylinder and a thread wound around an outer circumferential surface of the cylinder. The cylinder has a hole extending in an axial direction. The cylinder has flanges at both ends in the axial direction. A label containing a two-dimensional code is attached to a surface located at one end of the cylinder in the axial direction. In a condition that one axial end of the cylinder is upward, the surface located at the one axial end of the cylinder is the upper surface of the cylinder. The two-dimensional code indicates information indicating the color of the thread wound around the cylinder.

Examples of known two-dimensional code for a thread spool include QR code, VeriCode, CP codes, AztecCode, and PDF417. The upper or lower surface (base) of the cylinder of a thread spool may be small in area and difficult to place the two-dimensional code. The "QR Code" is a registered trademark of DENSO WAVE INCORPORATED.

In view of the foregoing, an example of an object of this disclosure is to provide a thread spool which contributes to increasing flexibility in arranging a two-dimensional code on a surface located at one end of the thread spool in the axial direction.

According to one aspect, this specification discloses a thread spool. The thread spool includes a cylinder having a hole extending in an axial direction. The cylinder includes an outer circumferential surface and a first surface. A thread is wound around the outer circumferential surface. The first surface is located at one end of the cylinder in the axial direction. A data matrix is disposed on the first surface.

The data matrix of the thread spool of this aspect contributes to showing a lot of information in a small space. The data matrix of the thread spool contributes to increasing flexibility in disposing a two-dimensional code on the first surface of the cylinder.

### BRIEF DESCRIPTION OF DRAWINGS

FIG. 1 is a perspective view of a first thread spool 81 having a thread number "001".

FIG. 2 is a plan view of the first thread spool 81.

FIG. 3 is a front view of the first thread spool 81.

FIG. 4 is a bottom view of the first thread spool 81.

FIG. 5A is a plan view of a data matrix 67.

FIG. 5B illustrates 16-digit alphanumeric characters shown in the data matrix 67.

FIG. 6 is a perspective view of a second thread spool 82 having a thread number "800".

FIG. 7 is a plan view of the second thread spool 82.

FIG. 8 is a perspective view of a third thread spool 83 having a thread number "900".

FIG. 9 is a plan view of the third thread spool 83.

FIG. 10 is a block diagram of a terminal apparatus 1.

FIG. 11 is a flowchart of a display process.

FIGS. 12A, 12B and 12C illustrate transitions of a screen G1.

FIG. 13 is a plan view of a thread spool 3 of a thread number "001".

### DESCRIPTION

An embodiment of the present disclosure will be described with reference to the drawings. The drawings referred to are used to illustrate the technical features that may be employed by the present disclosure. The configurations shown in the drawings are not intended to be limited to the configurations shown in the drawings, but are merely illustrative examples. In the following, the left and right, front and rear, and upper and lower indicated by the arrows in the drawing are used.

In this embodiment, a plurality of types of thread spools used when sewing a sewing workpiece to be sewn by a sewing machine are collectively referred to as a thread spool 2. The sewing workpiece is, for example, a fabric. The plurality of kinds of thread spools have different thread colors. The thread spool 2 having a white thread 87 is also referred to as a first thread spool 81. The structure of the thread spool 2 will be described with the first thread spool 81 as an example.

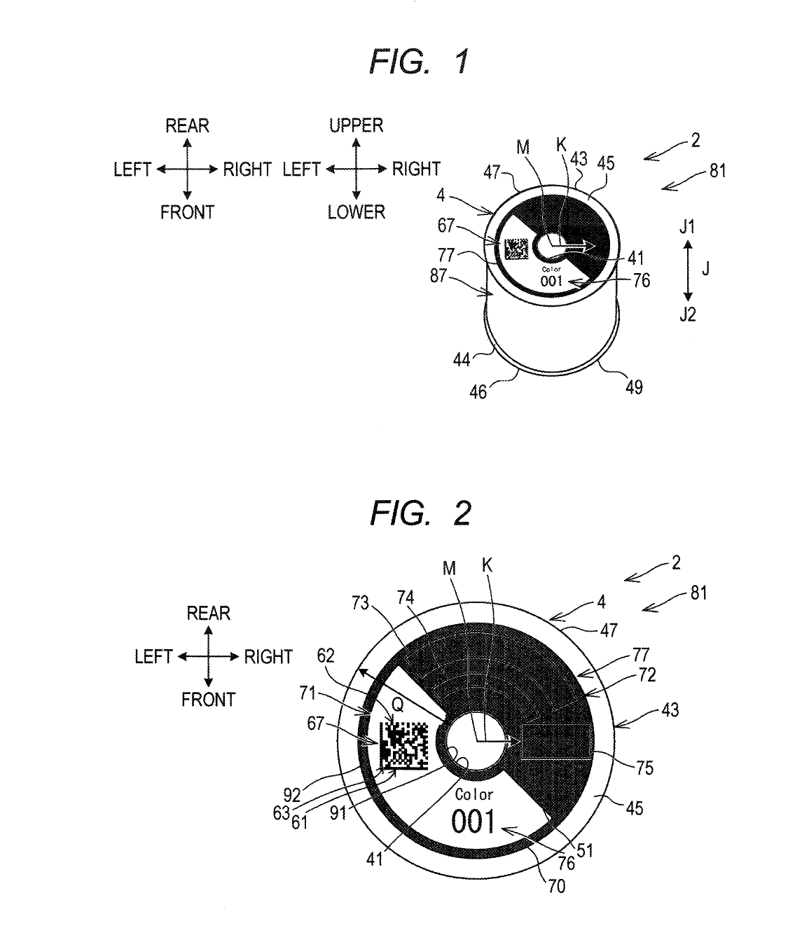

As shown in FIGS. 1 to 4, the first thread spool 81 includes the thread 87 and a cylinder 4 having a hole 41 extending in an axial direction J. The axial direction J of the present embodiment is the vertical direction.

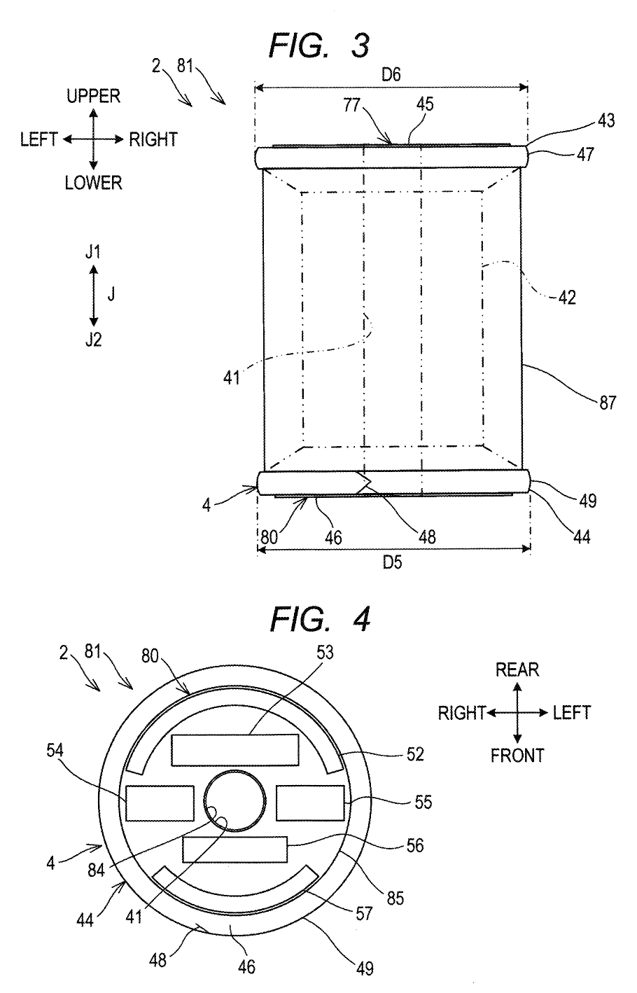

The cylinder 4 is a cylinder in which the axial direction J is the longitudinal direction of the cylinder. The cylinder 4 has an outer circumferential surface 42, a first flange 43, a second flange 44, a first surface 45, and a second surface 46. As shown in FIG. 3, the outer circumferential surface 42 is a curved surface around which the thread 87 is wound. The outer circumferential surface 42 is a part of the side surface of the cylinder 4. In the axial direction J, the outer circumferential surface 42 is located between the first flange 43 and the second flange 44.

The first flange 43 protrudes from the outer circumferential surface 42 in a radial direction K away from the hole 41 at an end of the cylinder 4 in the axial direction J. In a plan view, the radial direction K is a direction extending radially from a center M of the hole 41 of the cylinder 4. The radial direction K is a direction perpendicular to the axial direction J. In the present embodiment, one side J1 in the axial direction J is upward.

The second flange 44 protrudes from the outer circumferential surface 42 in the radial direction K at the end of the cylinder 4 in an other side J2 in the axial direction J. The other side J2 in the axial direction J of this embodiment is downward. A diameter D5 of the second flange 44 is the same as a diameter D6 of the first flange 43. The second flange 44 has a notch 48 which retains an end of the thread 87. The notch 48 is formed on an outer circumference 49 of the second flange 44. The notch 48 is V-shaped and opens on the left side.

As shown in FIG. 3, the first surface 45 is a surface of the cylinder 4 at the one side J1 in the axial direction J, that is, an upper surface of the cylinder 4. As shown in FIG. 2, in a plan view, the center M of the hole 41 is located at the center of the first surface 45. The first surface 45 is in the shape of a ring having a perfect circle in plan view. A data matrix 67 is disposed on the first surface 45. The data matrix 67 is disposed on the first surface 45 at a position where the data matrix 67 does not overlap the hole 41. In a plan view, the data matrix 67 is disposed between the hole 41 and an outer circumference 47 of the first flange 43. In the present embodiment, the data matrix 67 is disposed on the first surface 45 and is not disposed on the second surface 46.

A label 77 is attached (affixed) to the first surface 45 in the present embodiment. The label 77 is in the shape of a ring having a perfect circle in plan view. The label 77 is attached to a region between the hole 41 of the cylinder 4 and the outer circumference 47 of the first flange 43 in the radial direction K. In the radial direction K, an inner circumference 91 and an outer circumference 92 of the label 77 are located between the hole 41 and the outer circumference 47 of the first flange 43. The data matrix 67 is printed on the label 77. In the radial direction K, a length Q between the hole 41 of the cylinder 4 and the outer circumference 47 of the first flange 43 is 12.0 mm. In the embodiment, the dimensions are just examples.

As shown in FIG. 2, the label 77 has a first region 71 and a second region 72. The first region 71 has a white background and is a region where a plurality of black cells 65 of the data matrix 67 are printed in black. The first region 71 is a fan-shaped region in plan view occupying about half of the label 77. A contour 70 of the first region 71 is printed with black ink in a particular width. A boundary 51 between the first region 71 and the second region 72 extends in a direction crossing the front-rear direction and the left-right direction, more specifically, in a direction from the left rear to the right front.

The second region 72 is a region printed with a black background. The second region 72 is a fan-shaped region in plan view occupying about half of the label 77. The second region 72 has character regions 73, 74 and 75. In the character regions 73 to 75, character strings indicating information about the thread 87 are printed in a particular color. The particular color may be appropriately set in consideration of the color of the background of the second region 72. The particular color is, for example, gold.

The character region 73 is disposed rearward of the hole 41. The character region 73 is in the shape of an arc along the outer circumference 92 of the label 77. In the character region 73, for example, a character string indicating a product name is disposed.

The character region 74 is disposed rearward of the hole 41 and forward of the character region 73. The character region 74 is an arc shape along the character region 73. In the character region 74, for example, a character string indicating the material of the thread 87 is disposed. The character string indicating the material of the thread 87 is, for example, "polyester 100%".

The character region 75 is disposed on the right side of the hole 41. In the character region 75, a character string indicating the country of manufacture of the thread spool 2 is disposed. The character string indicating the country of manufacture of the thread spool 2 is, for example, "MADE IN JAPAN".

As shown in FIG. 3, the second surface 46 is a surface of the cylinder 4 at the other side J2 in the axial direction J, that is, a lower surface of the cylinder 4. The second surface 46 is a surface opposite to the first surface 45 in the axial direction J. A label 80 is attached to the second surface 46 of the present embodiment. In the present embodiment, the data matrix 67 is not disposed on the second surface 46. In the present embodiment, the data matrix 67 is disposed on the first surface 45 and is not disposed on the second surface 46. Therefore, the second surface 46 of the first thread spool 81 contains information that cannot be disposed on the first surface 45 due to a small space, such as the length and thickness of the thread 87 described later.

As shown in FIG. 4, the label 80 is in the shape of a ring having a perfect circle in plan view. The label 80 is disposed in a region between the hole 41 of the cylinder 4 and the outer circumference 49 of the second flange 44 in the radial direction K. In the radial direction K, an inner circumference 84 and an outer circumference 85 of the label 80 are located between the hole 41 and the outer circumference 49 of the second flange 44.

The background of the label 80 is white. The label 80 includes character regions 52, 53, 54, 55, 56 and 57 that indicate information about the thread 87. In the character regions 52 to 57, character strings related to the thread 87 are printed in a particular color. The particular color may be the same as or different from the character regions 73 to 75.

The character region 52 is disposed rearward of the hole 41. The character region 52 is an arc shape along the outer circumference 85 of the label 80. In the character region 52, for example, a character string indicating a product name is disposed. The character region 53 is disposed rearward of the hole 41 and forward of the character region 52. In the character region 53, for example, a character string indicating the vendor of the first thread spool 81 is disposed.

The character region 54 is disposed on the right side of the hole 41. In the character region 54, for example, a character string indicating the thickness of the thread 87 is disposed. The character string indicating the thickness of the thread 87 is, for example, "#50". The character region 55 is disposed on the left side of the hole 41. In the character region 55, a character string indicating the length of the thread 87, for example, is disposed. The character string indicating the length of the thread 87 is, for example, "300m".

The character region 56 is disposed forward of the hole 41. In the character region 56, a character string indicating the material of the thread 87, for example, is disposed. The character region 57 is disposed forward of the hole 41. The character region 57 is in the shape of an arc along the outer circumference 85 of the label 80. In the character region 57, for example, a character string indicating the manufacturer of the first thread spool 81 is disposed.

A thread number corresponding to the color of the thread 87 is disposed on the first surface 45 or the second surface 46. In the first thread spool 81 of the present embodiment, the thread number is printed in black in the first region 71 of the label 77 attached to the first surface 45. That is, in addition to the data matrix 67, the thread number is disposed on the first surface 45.

The thread number is disposed in the character region 76 of the first region 71. The character region 76 is located in the right front of the data matrix 67, that is, forward of the hole 41. The thread number is indicated by a three digit number. For example, the white thread 87 is assigned a thread number "001". That is, the thread number of the first thread spool 81 is "001".

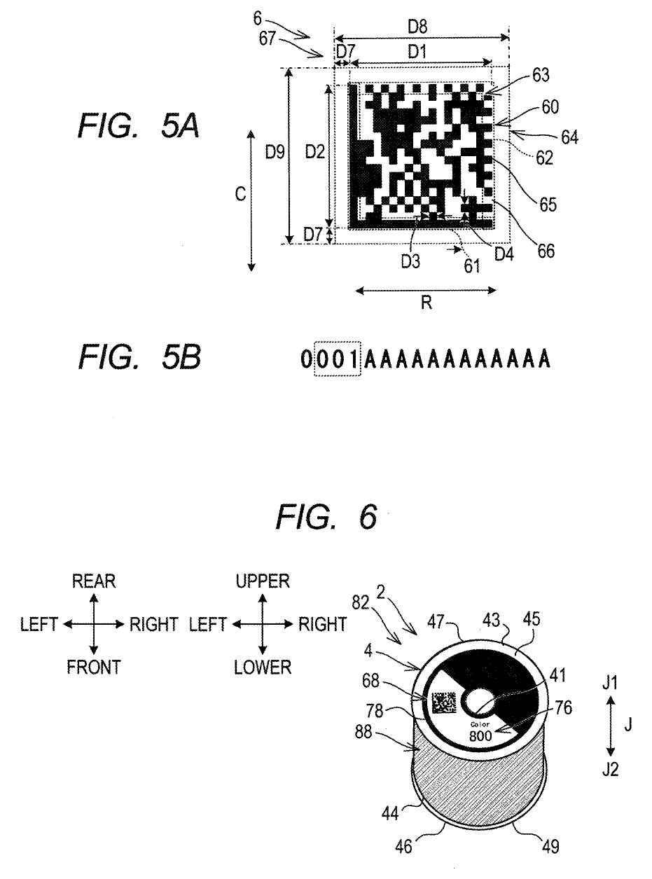

The data matrix 67 will be described with reference to FIGS. 5A and 5B. The data matrix disposed on the thread spool 2 is collectively referred to as a data matrix 6. The structure of the data matrix 6 will be described with reference to the data matrix 67 of the first thread spool 81 as an example.

As shown in FIG. 5A, the data matrix 67 has a block 60 and a quiet zone 64. The block 60 has a rectangular shape in which a plurality of black cells 65 and a plurality of white cells 66 are disposed in a grid pattern in a row direction R and a column direction C.

The size of the block 60 is, for example, 5 mm × 5 mm. That is, a length D1 of the block 60 in the row direction R is 5 mm. A length D2 of the block 60 in the column direction C is 5 mm. As shown in FIG. 2, the four sides of the block 60 extend in a direction crossing the boundary 51 between the first region 71 and the second region 72.

The plurality of black cells 65 and the plurality of white cells 66 are each square in plan view. The size of each of the plurality of black cells 65 and the plurality of white cells 66 is, for example, 0.3125 mm × 0.3125 mm. That is, a length D3 of the cells 65 and 66 in the row direction R is 0.3125 mm. A length D4 of the cells 65 and 66 in the column direction C is 0.3125 mm.

The block 60 has an alignment pattern 61, a clock pattern 62, and a data area 63. The alignment pattern 61 is two sides of the block 60, and a plurality of black cells 65 are disposed in an L-shape.

The clock pattern 62 has two sides different from the two sides indicating the alignment pattern 61, and black cells 65 and white cells 66 are alternately disposed. The clock pattern 62 is in an inverted L-shape with respect to the alignment pattern 61. The clock pattern 62 indicates the number of cells 65 and 66 in the row direction R and the number of cells 65 and 66 in the column direction C of the data area 63.

As shown in FIG. 2, the side of the clock pattern 62 extending in the column direction C is located between the hole 41 and the side of the alignment pattern 61 extending in the column direction C. A line segment connecting the center of the block 60 and the center M of the cylinder 4 crosses the clock pattern 62. A line segment connecting the center of the block 60 and the center M of the cylinder 4 does not cross the alignment pattern 61. The alignment pattern 61 and the clock pattern 62 are used to detect the data matrix 6 in image data. The image data is, for example, data of an image representing the thread spool 2, which is output by capturing the thread spool 2 in the real space by an image sensor 11 of the terminal apparatus 1.

As shown in FIG. 5A, the data area 63 is a region surrounded by the alignment pattern 61 and the clock pattern 62. The data area 63 is represented by cells of 16 cells × 16 cells. The total number of cells in the data area 63 is 256.

The quiet zone 64 indicates a margin of a width D7 of two or more cells disposed around the block 60. The width D7 of the quiet zone 64 is, for example, 0.625 mm. A length D8 obtained by adding the length D1 of one side of the block 60 in the row direction R and the widths D7 of the quiet zone 64 is 6.25 mm. A length D9 obtained by adding the length D2 of one side of the block 60 in the column direction C and widths D7 of the quiet zone 64 is 6.25 mm. The length D8 is the length of the data matrix 67 in the row direction R. The length D9 is the length of the data matrix 67 in the column direction C. That is, the lengths D8 and D9 obtained by adding the length of one side of the block 60 and the widths D7 of the quiet zone 64 are less than or equal to 12.0 mm, which is a length Q between the hole 41 and the outer circumference 47 of the first flange 43.

The data matrix 67 shows information about the thread 87. The information about the thread 87 indicated by the data matrix 67 may be set appropriately. The information about the thread 87 in this embodiment indicates the thread number corresponding to the color of the thread 87.

As shown in FIG. 5B, the data matrix 67 of this embodiment shows 16-digit alphanumeric characters. A part of the 16-digit alphanumeric characters indicates the thread number according to the color of the thread 87. In detail, the three digit numbers from the second digit to the fourth digit from the left surrounded by the dotted line among the 16-digit alphanumeric characters indicate the thread number corresponding to the color of the thread 87. The alphanumeric characters of the first digit from the left and the alphanumeric characters of the fifth to sixteenth digits from the left may include information about the thread 87 other than the thread number. The information about the thread 87 other than the thread number may be selected from character strings indicated by the character regions 52 to 57 and the character regions 73 to 75, or may be other information.

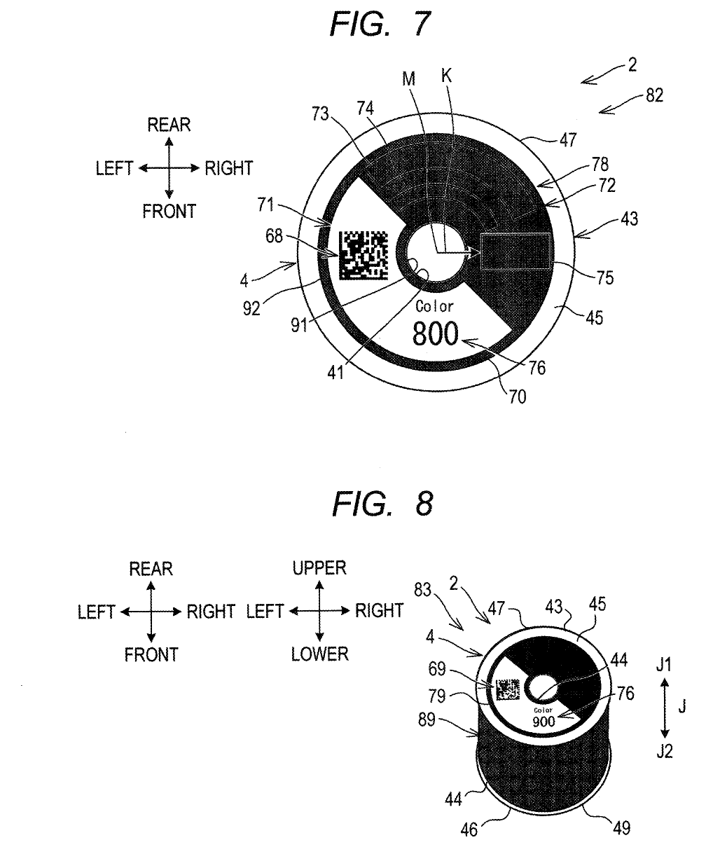

A second thread spool 82 will be described with reference to FIGS. 6 and 7. In FIGS. 6 and 7, the same reference numerals are given to the same components as those of the first thread spool 81. The description of the same configuration as the first thread spool 81 is omitted or simplified.

As shown in FIG. 6, the second thread spool 82 is the thread spool 2 having a red thread 88. The second thread spool 82 includes the thread 88 and the cylinder 4 having the hole 41 extending in the axial direction J. The thread 88 is wound around the outer circumferential surface 42 of the cylinder 4. A label 78 is attached to the first surface 45.

As shown in FIG. 7, the label 78 differs from the label 77 in that a data matrix 68 is disposed instead of the data matrix 67. The data area 63 of the data matrix 68 shows 16-digit alphanumeric characters. A part of the 16-digit alphanumeric characters indicates a thread number "800" according to the color of the thread 88.

The label 78 is different from the label 77 in that "008" corresponding to the red thread 88 of the second thread spool 82 is disposed in the character region 76 instead of "100" corresponding to the white thread 87 of the first thread spool 81. The structure of the label 78 is the same as that of the label 77 except for the data matrix 68 and the character region 76.

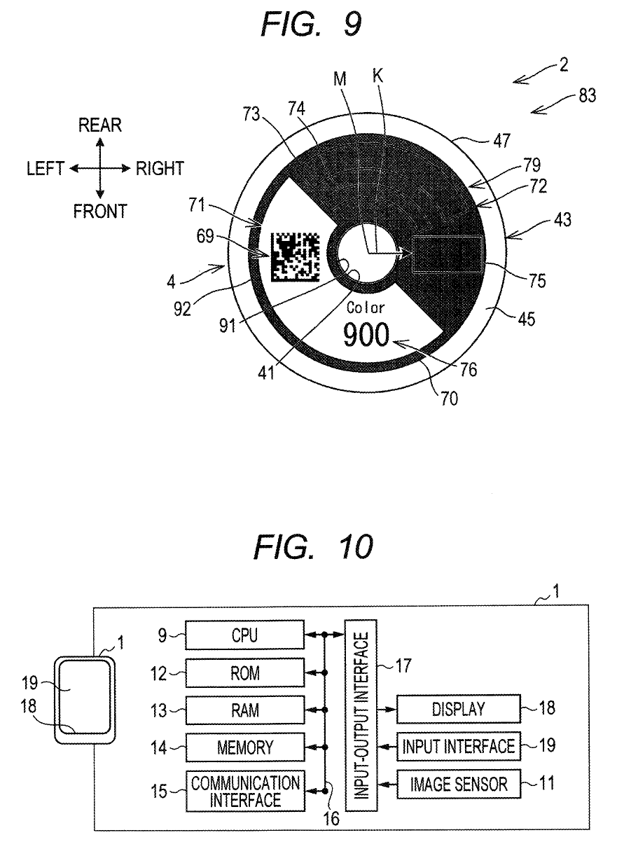

A third thread spool 83 will be described with reference to FIGS. 8 and 9. In FIGS. 8 and 9, the same reference numerals are given to the same components as those of the first thread spool 81. The description of the same configuration as the first thread spool 81 is omitted or simplified.

As shown in FIG. 8, the third thread spool 83 is the thread spool 2 having a black thread 89. The third thread spool 83 includes the thread 89 and the cylinder 4 having the hole 41 extending in the axial direction J. The thread 89 is wound around the outer circumferential surface 42 of the cylinder 4. A label 79 is attached to the first surface 45.

As shown in FIG. 9, the label 79 differs from the label 77 in that a data matrix 69 is disposed instead of the data matrix 67. The data area 63 of the data matrix 69 represents a 16-digit alphanumeric character. A part of the 16-digit alphanumeric character indicates the thread number "900" according to the color of the thread 89.

The label 79 is different from the label 77 in that "900" corresponding to the black thread 89 of the third thread spool 83 is disposed in the character region 76 instead of "001" corresponding to the white thread 87 of the first thread spool 81. The structure of the label 79 is the same as that of the label 77 except for the data matrix 69 and the character region 76.

As described above, the thread number corresponding to the color of the thread is assigned to the thread spool 2. The color of the thread 87 of the first thread spool 81, the color of the thread 88 of the second thread spool 82, and the color of the thread 89 of the third thread spool 83 are different from each other. Therefore, the thread number of the thread 87 of the first thread spool 81, the thread number of the thread 88 of the second thread spool 82, and the thread number of the thread 89 of the third thread spool 83 are different from each other. The data matrix 6 of the thread spool 2 indicates a thread number. Therefore, the data matrix 67 disposed on the first surface 45 of the first thread spool 81, the data matrix 68 disposed on the first surface 45 of the second thread spool 82, and the data matrix 69 disposed on the first surface 45 of the third thread spool 83 are different from each other.

The electrical configuration of the terminal apparatus 1 will be described with reference to FIG. 10. The terminal apparatus 1 has a function of displaying information about the thread indicated by the data matrix 6 based on image data obtained by capturing the first surface 45 of the thread spool 2. The terminal apparatus 1 is a tablet type portable terminal apparatus or a smartphone.

As shown in FIG. 10, the terminal apparatus 1 includes a central processing unit (CPU) 9, a read only memory (ROM) 12, a random access memory (RAM) 13, a memory 14, a communication interface 15, an input-output interface 17, the image sensor 11, a display 18, and an input interface 19. The communication interface 15 may be referred to as a "communication IF 15". The input-output interface 17 may be referred to as I/O 17. The input interface 19 may be referred to as an input IF 19.

The CPU 9 controls the terminal apparatus 1. The CPU 9 is electrically connected to the ROM 12, the RAM 13, the memory 14, the communication interface 15, and the input-output interface 17 via a bus 16. The ROM 12 stores various programs and setting values. The CPU 9 causes the RAM 13 to store temporary data.

The memory 14 is a nonvolatile storage device such as a flash memory. The memory 14 stores various setting values for executing the processing described later. The memory 14 stores thread numbers, the RGB values of threads, and color names in association with one another.

The communication interface 15 is an interface for connecting the terminal apparatus 1 to a network. The CPU 9 transmits and receives data to and from other devices connected to the network, for example, a sewing machine and a server, via the communication interface 15. The input-output interface 17 is connected to the display 18, the input interface 19, and the image sensor 11.

The display 18 is, for example, a liquid crystal display. The input interface 19 is, for example, a touch screen and is used for inputting various instructions. In response to an operation of the input interface 19 by the user, the input interface 19 outputs a signal corresponding to the operation of the user to the CPU 9. The image sensor 11 is a digital camera including an imaging device such as a CCD and a CMOS, and an imaging lens. For example, when the user captures the thread spool 2 in the real space by the image sensor 11, the image sensor 11 outputs an image indicating the thread spool 2.

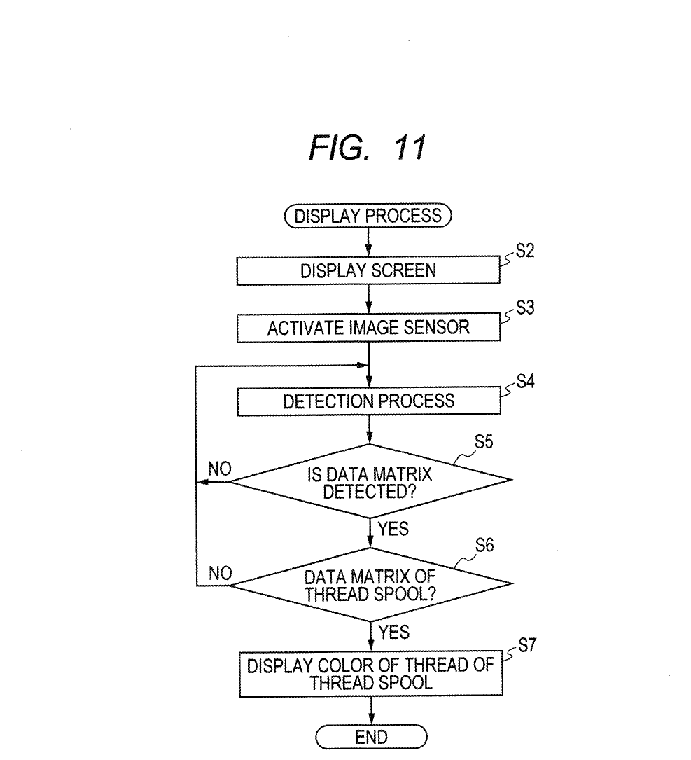

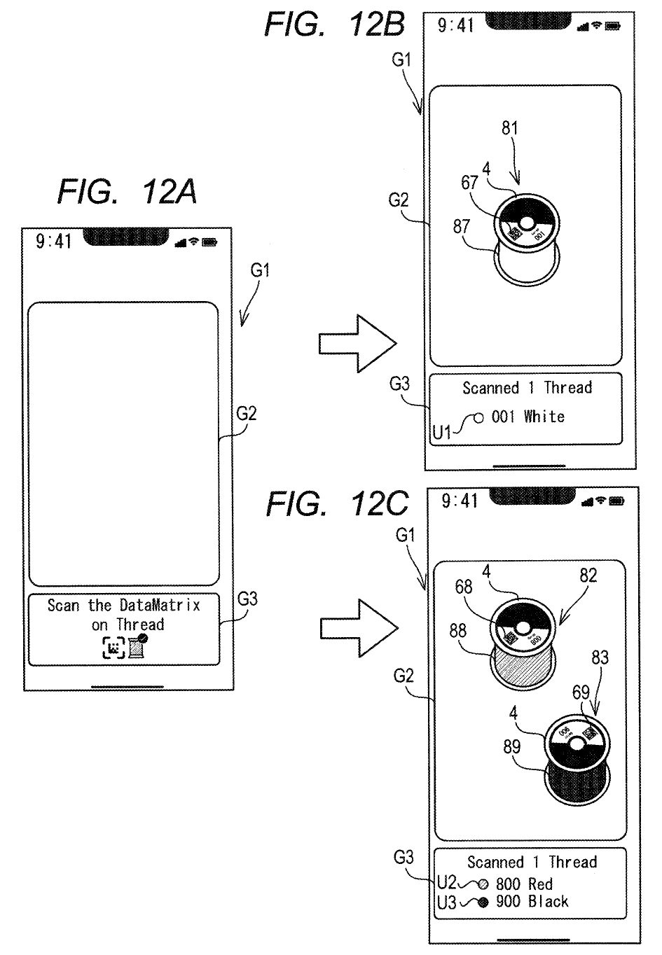

The display process executed by the terminal apparatus 1 will be described with reference to FIGS. 11 and 12. The user operates the input interface 19 to input an instruction to start the display process. The CPU 9 detects an instruction to start the display process based on a signal output from the input interface 19. In response to detecting an instruction to start the display process, the CPU 9 reads a program for executing the display process stored in the program storage area of the memory 14 to the RAM 13. The program includes instructions for causing the CPU 9 to execute the following processing. The CPU 9 executes the following steps in accordance with instructions included in the program read out to the RAM 13. Hereinafter, the step is abbreviated as S.

As shown in FIG. 11, the CPU 9 displays a screen G1 prior to activation of the image sensor 11 on the display 18 (S2). As shown in FIG. 12A, the screen G1 includes fields G2 and G3. The field G2 displays a captured image output from the image sensor 11. The field G3 displays information about the thread of the thread spool 2 indicated by the data matrix 6 detected from the captured image displayed in the field G2. The CPU 9 displays a message for prompting the user to read the data matrix 6 in the field G3.

The CPU 9 activates the image sensor 11 to display the captured image in the field G2 (S3). The user captures the first surface 45 of the thread spool 2 with the image sensor 11 in accordance with the message in the field G3. That is, the user captures the image by directing the imaging lens of the image sensor 11 to the thread spool 2 of the display target. The CPU 9 displays the captured image output from the image sensor 11, that is, the image indicating the thread spool 2 of the display target, in the field G2. In the present embodiment, the image sensor 11 is automatically activated after S2. The terminal apparatus 1 may be configured to activate the image sensor 11 at a requested timing by the user's operation of the input interface 19.

The CPU 9 detects the data matrix 6 from the captured image (S4). The CPU 9 may exclude the second region 72 having a black background from the region of the detection target including the data matrix 6. The CPU 9 may detect the data matrix 6 from the first region 71 having a white background as follows. The CPU 9 may detect the data matrix 6 in the captured image by using the alignment pattern 61 and the clock pattern 62 in the block 60 of the data matrix 6. When the data matrix 6 is not present in the captured image displayed in the field G2, the data matrix 6 is not detected. In a case where a plurality of data matrices 6 are contained in the captured image displayed in the field G2, the plurality of data matrices 6 may be detected.

The CPU 9 determines whether the data matrix 6 is detected in S4 (S5). In response to determining that the data matrix 6 is not detected (S5: NO), the CPU 9 returns the processing to S4. In response to determining that the data matrix 6 is detected (S5: YES), the CPU 9 advances the processing to S6.

The CPU 9 determines whether the data matrix detected in S4 is the data matrix 6 of the thread spool 2 (S6). The determination method in S6 may be set as appropriate. The CPU 9 decodes the detected data matrix 6, for example, and acquires alphanumeric characters indicated by the data matrix 6. In response to determining that the 3-digit numbers from the 2nd to 4th digits of the 16-digit alphanumeric characters indicated by the data matrix 6 are stored in the memory 14 as a thread number, the CPU 9 determines that the detected data matrix is the data matrix 6 of the thread spool 2. In response to determining that the detected data matrix is not the data matrix 6 of the thread spool 2 (S6: NO), the CPU 9 returns the processing to S4.

In response to determining that the data matrix detected in S4 is the data matrix 6 of the thread spool 2 (S6: YES), the CPU 9 advances the processing to S7. The CPU 9 displays information about the thread indicated by the data matrix 6 of the thread spool 2 in the field G3 (S7). The information about the thread includes a thread number, a thread color name, and a thread color. The color is acquired by referring to the memory 14 and identifying the RGB value corresponding to the thread number indicated by the data matrix 6.

When the data matrix 67 is detected, as shown in FIG. 12B, the CPU 9 displays a circular icon U1 of the color of the thread 87, the thread number "001" of the thread 87, and the thread name "White" in the field G3 (S7). When the data matrices 68 and 69 are detected, as shown in FIG. 12C, the CPU 9 displays a circular icon U2 of the color of the thread 88, the thread number "800" of the thread 88, and the thread name "Red" in the field G3 (S7). The CPU 9 also displays a circular icon U3 of the color of the thread 89, the thread number "900" and the thread name "Black" of the thread 89 in the field G3 (S7). The CPU 9 ends the display process.

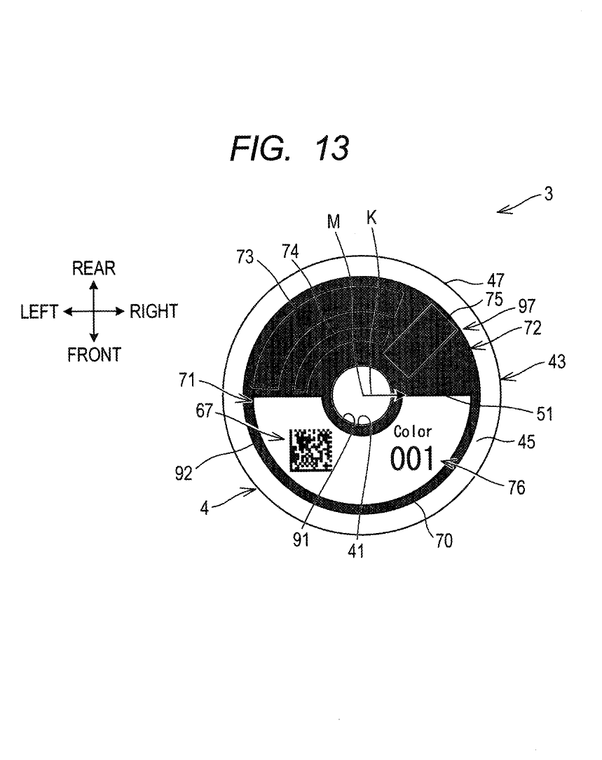

In the thread spool 2 of the above embodiment, the layout of the labels 77 to 79 may be changed as appropriate. For example, the layout of the label 77 may be changed as in the case of a label 97 of the thread spool 3 of a modification shown in FIG. 13. In FIG. 13, the same reference numerals are given to the same components as those of the first thread spool 81. As shown in FIG. 13, the thread spool 3 of the modification is different from the first thread spool 81 of the above embodiment in that the label 97 is attached to the first surface 45 instead of the label 77, and the other configuration is the same as the first thread spool 81. The same structure as the first thread spool 81 will be omitted or simplified, and the label 97 will be described.

The label 97 has the first region 71 and the second region 72 similar to the label 77. The boundary 51 between the first region 71 and the second region 72 extends in the left-right direction. The data matrix 67 and the character region 76 are disposed in the first region 71. Two sides of the block 60 of the data matrix 67 extend parallel to the boundary 51. The character region 76 is disposed parallel to the boundary 51. The data matrix 67 and the character region 76 are disposed in the left-right direction.

In the above embodiment and modification, the thread spools 2 and 3, the first thread spool 81, the second thread spool 82, and the third thread spool 83 are examples of a thread spool of the present disclosure. The cylinder 4 is an example of a cylinder of the present disclosure. The data matrices 6, 67, 68 and 69 are examples of a data matrix of the present disclosure. The labels 77, 78, 79 and 97 are examples of a label of the present disclosure. The hole 41 is an example of a hole of the present disclosure. The outer circumferential surface 42 is an example of an outer circumferential surface of the present disclosure. The first flange 43 is an example of a first flange of the present disclosure. The second flange 44 is an example of a second flange of the present disclosure. The first surface 45 is an example of a first surface of the present disclosure. The second surface 46 is an example of a second surface of the present disclosure. The outer circumference 47 is an example of an outer circumference of the present disclosure. The notch 48 is an example of a notch of the present disclosure.

The block 60 is an example of a block of the present disclosure. The alignment pattern 61 is an example of an alignment pattern of the present disclosure. The clock pattern 62 is an example of a clock pattern of the present disclosure. The data area 63 is an example of a data area of the present disclosure. The quiet zone 64 is an example of a quiet zone of the present disclosure. The cells 65 and 66 are examples of cells of the present disclosure.

The first region 71 is an example of a first region of the present disclosure. The second region 72 is an example of a second region of the present disclosure. The threads 87 to 89 are examples of a thread of the present disclosure. The axial direction J is an example of an axial direction of the present disclosure. The one side J1 is an example of one side in the axial direction of the present disclosure. The other side J2 is an example of the other side in the axial direction of the present disclosure. The radial direction K is an example of a radial direction of the present disclosure.

The first thread spool 81 of the above embodiment includes the thread 87 and the cylinder 4 having the hole 41 extending in the axial direction J. The cylinder 4 has the outer circumferential surface 42 and the first surface 45. The outer circumferential surface 42 is a curved surface around which the thread 87 is wound. The first surface 45 is a surface located at the end at the one side J1 in the axial direction J. The data matrix 67 is disposed on the first surface 45. The data matrix 67 of the first thread spool 81 stores a large amount of information in a small space, and contributes to increasing flexibility in arranging the two-dimensional code on the first surface 45.

The first thread spool 81 has the first flange 43 and the second flange 44. The first flange 43 protrudes in the radial direction K away from the hole 41 from the outer circumferential surface 42 at the end at the one side J1 in the axial direction J of the cylinder 4. The second flange 44 protrudes in the radial direction K from the outer circumferential surface 42 at the end at the other side J2 in the axial direction J of the cylinder 4. The first flange 43 and the second flange 44 of the first thread spool 81 contribute to reducing the movement of the thread 87 in the axial direction J along the outer circumferential surface 42.

The data matrix 6 is disposed on the first surface 45 and is not disposed on the second surface 46. The first thread spool 81 contributes to arranging information that cannot be disposed on the first surface 45 due to a small space at a place other than the first surface 45.

The data matrix 67 shows the rectangular block 60 in which a plurality of black cells 65 and a plurality of white cells 66 are disposed in a grid shape. Two adjacent sides of the block 60 indicate the alignment pattern 61 in which a plurality of black cells 65 are disposed in an L-shape. Two adjacent sides other than the two adjacent sides indicating the alignment pattern 61 indicate the clock pattern 62 in which the black cells 65 and the white cells 66 are alternately disposed. The data matrix 67 of the first thread spool 81 has a simple structure and contributes to increasing flexibility in arranging the two-dimensional code on the first surface 45.

One of the two sides of the clock pattern 62 is disposed between the hole 41 and one of the two sides of the alignment pattern 61. The data matrix 67 of the first thread spool 81 has a simple structure and contributes to increasing flexibility in arranging the two-dimensional code on the first surface 45. In the data matrix 67 of the first thread spool 81, the distance between the alignment pattern 61 and the hole 41 is longer, compared with a thread spool in which one of the two sides of the alignment pattern 61 is disposed between the hole 41 and one of the two sides of the clock pattern 62. Therefore, the data matrix 67 of the first thread spool 81 contributes to making it easier to prevent the alignment pattern 61 from being damaged due to a spool pin being inserted into the hole 41, as compared with a thread spool of a comparative example. In the thread spool of the comparative example, one of the two sides of the alignment pattern 61 is disposed between the hole 41 and one of the two sides of the clock pattern 62.

The data matrix 67 has the quiet zone 64 around the block 60 which indicates a margin of two or more cells wide. The data matrix 67 of the first thread spool 81 contributes to making it easier for the reader of the terminal apparatus 1 and so on to detect the alignment pattern 61 and the clock pattern 62, as compared with the thread spool having a margin of one cell width around the block 60.

The data matrix 67 shows information about the thread 87. The data matrix 67 of the first thread spool 81 is read by the terminal apparatus 1 and so on, and contributes to showing the information about the thread 87 to the user of the first thread spool 81.

The information about the thread 87 indicates the thread number corresponding to the color of the thread 87. The data matrix 67 of the first thread spool 81 is read by the terminal apparatus 1 and so on, and contributes to showing thread information corresponding to the color of the thread 87 to the user of the first thread spool 81.

The data matrix 67 shows 16-digit alphanumeric characters. The data matrix 6 of the first thread spool 81 contributes to showing the information about the first thread spool 81 to the user by 16-digit alphanumeric characters. The data matrix 67 of the first thread spool 81 contributes to indicating the information about the thread 87 with a relatively small amount of information of 16 digits.

A part of the 16-digit alphanumeric characters indicates the thread number according to the color of the thread 87. The data matrix 67 of the first thread spool 81 is read by the terminal apparatus 1 and so on, and thereby contributes to the user who decodes the data matrix 67 to grasp the thread number.

The data matrix 67 is disposed at a position not overlapping the hole 41. The data matrix 67 of the first thread spool 81 contributes to preventing the alignment pattern 61 from being damaged due to the insertion of the spool pin into the hole 41, compared with the thread spool in which the data matrix 67 is disposed at a position overlapping the hole 41.

The data matrix 67 is disposed between the hole 41 and the outer circumference 47 of the first flange 43. The data matrix 67 of the first thread spool 81 contributes to making it easier to avoid the alignment pattern 61 from being damaged, compared with a thread spool in which the data matrix 67 protrudes from the space between the hole 41 and the outer circumference 47 of the first flange 43.

The data matrix 67 shows the rectangular block 60 in which a plurality of cells 65 and 66 are disposed in a grid pattern. The block 60 includes the data area 63 surrounded by the alignment pattern 61 and the clock pattern 62. The data area 63 includes cells of 16 cells × 16 cells. The data matrix 67 of the first thread spool 81 contributes to making the size of the two-dimensional code indicating the information about the thread relatively small, such as 16 cells × 16 cells.

The data matrix 67 shows the rectangular block 60 in which a plurality of cells 65 and 66 are disposed in a grid pattern. The block 60 is 5 mm by 5 mm in size. The first thread spool 81 contributes to making the size of the data matrix 67 a size that is contained in a relatively small space.

The data matrix 67 shows the rectangular block 60 in which a plurality of cells 65 and 66 are disposed in a grid pattern. The size of each of the plurality of cells 65, 66 is 0.3125 mm × 0.3125 mm. The first thread spool 81 contributes to making the size of the cells 65 and 66 of the data matrix 67 a size that enables decoding the data matrix 67.

The lengths D8 and D9 obtained by adding the length of one side of the block 60 and the widths D7 of the quiet zone 64 are less than or equal to 12.0 mm. The data matrix 67 contributes to reducing the space for arranging the two-dimensional code, compared with a thread spool in which the lengths D8 and D9 obtained by adding the length of one side of the block 60 and the widths D7 of the quiet zone 64 are greater than 12.0 mm.

The cylinder 4 has the second surface 46 which is a surface located at the end at the other side J2 in the axial direction J. The thread number corresponding to the color of the thread 87 is disposed on the first surface 45 or the second surface 46. The first thread spool 81 contributes to improving the convenience of the user in acquiring the thread number, compared with a thread spool in which the thread number is not disposed on the first surface 45 or the second surface 46.

On the first surface 45, the thread number is disposed in addition to the data matrix 67. The first thread spool 81 contributes to improving the convenience of the user in acquiring the thread number, compared with a thread spool in which the thread number is disposed on the second surface 46.

The first surface 45 has the first region 71 having a white background and the second region 72 having a color other than white. The data matrix 67 is disposed in the first region 71. The first thread spool 81 contributes to reducing the user's labor for decoding the data matrix 67 while visually reading the thread number, compared with a thread spool in which the data matrix 67 and the thread number are disposed on different surfaces.

The thread number is disposed in the first region 71. The thread number of the first thread spool 81 contributes to making the thread number more visible to the user than a thread spool having the thread number disposed in the second region 72.

The first thread spool 81 has the label 77 attached to the first surface 45. The data matrix 67 is printed on the label 77. The label 77 of the first thread spool 81 contributes to simplifying the manufacturing process of the thread spool as compared with a thread spool in which the data matrix 67 is printed directly on the cylinder 4.

The label 77 has the first region 71 and the second region 72. The first region 71 has a white background, and is a region in which a plurality of black cells 65 of the data matrix 67 and the thread number corresponding to the color of the thread 87 is printed in black. The second region 72 is a region printed with a black background. The label 77 of the first thread spool 81 contributes to making the thread number more easily visible to the user than a thread spool in which the thread number is printed in the second region 72. The label 77 of the first thread spool 81 contributes to facilitating detecting the data matrix 6 from the label, as compared with a thread spool having a label in which the entire background is white.

The second flange 44 has the notch 48 which retains the end of the thread 87. The notch 48 in the first thread spool 81 contributes to retaining the end of the thread 87 as compared to a spool without the notch 48. The notch 48 of the first thread spool 81 contributes to preventing the label 77 from being damaged when the user puts the end of the thread 87 in the notch 48, compared with a thread spool in which the notch is formed in the first flange 43.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

The arrangement and configuration of the data matrix 6 may be changed as appropriate. For example, the one of the two sides of the clock pattern 62 extending in the row direction R may be disposed between the hole 41 and the one of the two sides of the alignment pattern 61 extending in the row direction R. In the data matrix 67 of the first thread spool 81, one of the two sides of the alignment pattern 61 may be disposed between the hole 41 and one of the two sides of the clock pattern 62.

The thread spool 2 may not have a label, and the data matrix 6 may be printed directly on the cylinder 4. In the thread spool 2, the label 80 on the second surface 46 may be omitted. The color, size, shape, and arrangement of the label 77 may be changed as appropriate.

The data matrix 67 may have the quiet zone 64 around the block 60, indicating a margin of one cell width. The data matrix 67 may not indicate the information about the thread 87. The information about the thread 87 may not include the thread number corresponding to the color of the thread 87. The color, material, thickness, length, and so on, of the thread 87 may be changed as appropriate.

The data matrix 6 may not indicate 16-digit alphanumeric characters. The number of cells 65 and 66 in the block 60 may be varied as appropriate. The data matrix 6 may be rectangular, and the number of cells in the row direction R and the number of cells in the column direction C may be the same or different. The data matrix 6 may indicate a number of digits, alphanumeric characters, or binary corresponding to the number of cells 65 and 66. All of the 16-digit alphanumeric characters may indicate the thread number corresponding to the color of the thread 87.

The size of the cells 65 and 66 may be changed as appropriate. The size of each of the plurality of black cells 65 and the plurality of white cells 66 may be, for example, 0.5 mm × 0.5 mm. The size of the block 60 may be changed as appropriate according to the size of the cells 65 and 66 and the number of the cells 65 and 66. The thread number may be disposed on the second surface 46. The thread spool having the thread number disposed on the second surface 46 contributes to increasing the size of the thread number since the data matrix 6 is not disposed on the same surface.

The data matrix 6 may be disposed on the first surface 45 and the second surface 46. In the thread spool 2 in which the data matrix 67 is disposed on the first surface 45 and the second surface 46, the user is allowed to read the data matrix 6 by capturing the upper surface of the thread spool 2, regardless of which of the first surface 45 and the second surface 46 of the first thread spool 81 is placed upward.

The first surface 45 may have the first region 71 having a white background, without the second region 72. The first surface 45 may have the second region 72 having a color other than white background, without the first region 71. The first surface 45 may have a third region in addition to the first region 71 and the second region 72. The shape, size, color, and arrangement of the first region 71 and the second region 72 may be changed as appropriate. The thread number may be disposed in the second region 72. The first region 71 and the second region 72 may or may not include a character region.

Some or all of the character regions 52 to 57 and the character regions 73 to 75 may be omitted. The thread spool 2 may have a character region different from the character regions 52 to 57 and the character regions 73 to 75. The character strings, the arrangement, the shape, the size, and so on, of the character regions 52 to 57 and the character regions 73 to 75 may be changed as appropriate. In the second flange 44, the notch 48 that retains the end of the thread 87 may be omitted. The notch 48 may be formed in the first flange 43. The shape and arrangement of the notch 48 may be changed as appropriate.

The data matrix 6 may be disposed on a spool that is used in a multi-needle sewing machine and that does not include the second flange 44. In the thread spool not having the second flange 44, the data matrix 6 is disposed on the first surface 45 having a larger space than the second surface 46. The data matrix 6 may be disposed on the second surface 46.

The device for reading the data matrix 6 may be a dedicated reader. The manner of using the information about the thread 87 decoded by using the data matrix 6 may be changed as appropriate. For example, the information about the thread 87 indicated by the data matrix 6 may be used in a process of detecting a specific thread spool 2 from among the plurality of thread spools 2.

What is claimed is:

1. A thread spool comprising:
a cylinder having a hole extending in an axial direction,
the cylinder including:
an outer circumferential surface around which a thread is wound; and
a first surface located at one end of the cylinder in the axial direction, a data matrix being disposed on the first surface.

2. The thread spool according to claim 1, wherein the cylinder includes:
a first flange protruding from the outer circumferential surface in a radial direction away from the hole at the one end of the cylinder in the axial direction; and
a second flange protruding from the outer circumferential surface in the radial direction at another end of the cylinder in the axial direction.

3. The thread spool according to claim 1, wherein the data matrix is disposed on the first surface and is not disposed on surfaces other than the first surface.

4. The thread spool according to claim 1, wherein the data matrix indicates a rectangular block in which a plurality of black cells and a plurality of white cells are disposed in a grid pattern;
wherein two adjacent sides of the block indicate an alignment pattern in which black cells are disposed in an L-shape; and
wherein two adjacent sides other than the two adjacent sides indicating the alignment pattern indicate a clock pattern in which black cells and white cells are alternately disposed.

5. The thread spool according to claim 4, wherein one of the two adjacent sides of the clock pattern is disposed between the hole and one of the two adjacent sides of the alignment pattern.

6. The thread spool according to claim 5, wherein the data matrix includes a quiet zone around the block, the quiet zone indicating a margin having a width of two or more cells.

7. The thread spool according to claim 1, wherein the data matrix indicates information about the thread.

8. The thread spool according to claim 7, wherein the information about the thread indicates a thread number corresponding to a color of the thread.

9. The thread spool according to claim 1, wherein the data matrix indicates 16-digit alphanumeric characters.

10. The thread spool according to claim 9, wherein a part of the 16-digit alphanumeric characters indicates a thread number corresponding to a color of the thread.

11. The thread spool according to claim 1, wherein the data matrix is disposed at a position where the data matrix does not overlap the hole.

12. The thread spool according to claim 1, wherein the data matrix is disposed between the hole and an outer circumference of the first surface.

13. The thread spool according to claim 4, wherein the block includes a data area surrounded by the alignment pattern and the clock pattern; and
wherein the data area includes cells of 16 × 16 cells.

14. The thread spool according to claim 1, wherein the data matrix indicates a rectangular block in which a plurality of cells are disposed in a grid shape; and
wherein the block has a size of 5mm × 5mm.

15. The thread spool according to claim 1, wherein the data matrix indicates a rectangular block in which a plurality of cells are disposed in a grid shape; and
wherein a size of each of the plurality of cells is 0.3125 mm × 0.3125 mm.

16. The thread spool according to claim 6, wherein a length obtained by adding a length of one side of the block and a width of the quiet zone is less than or equal to 12.0 mm.

17. The thread spool according to claim 1, wherein the cylinder further includes a second surface located at another end of the cylinder in the axial direction; and
wherein a thread number corresponding to a color of the thread is disposed on the first surface or the second surface.

18. The thread spool according to claim 17, wherein the thread number is disposed on the first surface.

19. The thread spool according to claim 18, wherein the first surface includes a first region having a white background and a second region having a background of a color other than white; and
wherein the data matrix is disposed in the first region.

20. The thread spool according to claim 19, wherein the thread number is disposed in the first region.

21. The thread spool according to claim 1, further comprising a label attached to the first surface,
wherein the data matrix is printed on the label.

22. The thread spool according to claim 21, wherein the label includes:
a first region having a white background, a plurality of black cells of the data matrix being printed in the first region, a thread number corresponding to a color of the thread being printed in black in the first region; and
a second region where a black background is printed.

23. The thread spool according to claim 2, wherein the second flange has a notch for retaining an end of the thread.
